(19) United States
(12) Patent Application Publication
(10) Pub. No.: US 2009/0183793 A1
(43) Pub. Date: Jul. 23, 2009

(54) TAP

(76) Inventors: Matti Weineland, Boras (SE); Lars Nothall, Vargarda (SE); Carl-Olof Redin, Astol (SE)

Correspondence Address: GAUTHIER & CONNORS, LLP, 225 FRANKLIN STREET, SUITE 2300, BOSTON, MA, 02110, US

(21) Appl. No.: 12/344,861

(22) Filed: Dec. 29, 2008

Related U.S. Application Data
(63) Continuation of application No. PCT/SE2007/000589, filed on Jun. 15, 2007.

(30) Foreign Application Priority Data
Jul. 3, 2006 (SE) 0601474-0

(51) Int. Cl. B67D 5/00; C22C 21/00

(52) U.S. Cl. 137/801; 420/532

(57) ABSTRACT

Tap for connecting to a fluid outlet, such as a pipe whereby the tap comprises a part having a surface that is arranged to come into contact with fluid when the tap is in use and which is manufactured from the extruded or forged aluminum or an extruded or forged aluminum alloy.

### TECHNICAL FIELD

The present invention concerns a tap (i.e. a device comprising a spout and valve, which controls the flow of a fluid) for connecting to a fluid outlet, such as a pipe.

### BACKGROUND OF THE INVENTION

Many conventional taps are made of brass, an alloy consisting essentially of copper and zinc in variable proportions. A problem with brass taps is that the copper and zinc contained in the brass alloy tend to oxidize if they come into contact with atmospheric oxygen. Oxidation produces a mixture of copper and zinc oxides which build a visible, noxious coating on the tap. In order to avoid such oxidation it is necessary to carry out further processing, such as chroming or painting, on the manufactured tap in order to maintain the shine and brightness of the un-oxidized brass alloy.

It is known that chroming processes may be noxious from an environmental point of view. Furthermore, it is known that brass alloys may contain lead, which is known to be a dangerous pollutant. In order to solve this problem a series of processes involving de-leading of brass alloys has been developed, aiming at eliminating lead from brass alloys. However, de-leading processes for brass alloys increase the cost of the brass objects. Furthermore, brass alloys tend to release their constituent components with time. The gradual and continuous release of copper and zinc from brass taps is a source of contamination for drinking water, especially when the water remains unused inside the tap for a long time, and it contaminates the environment when the water is released back into the natural environment.

Using steel alloys for taps avoids some of the aforesaid drawbacks, however, the use of steel may result in a longer manufacturing time and higher costs. Furthermore, due to its chemical and physical properties, steel has a drawback deriving from its low workability with respect to brass alloys.

European patent application no. EP 1340 828 discloses a tap whose main body comprises a cast aluminium-magnesium alloy. A cast aluminium tap not only avoids the aforesaid drawbacks encountered with brass taps but is easily recyclable, it complies with health regulations concerning food contamination and has a weight that is up to a third less than a tap made of brass or steel, which makes it cheaper to transport.

Aluminium and aluminium alloys are suitable for the manufacture of taps due to their mechanical and corrosion properties. However, the casting process adversely affects these properties. Even under optimum melting and melt-holding conditions, molten aluminum is susceptible to degradation by adsorption of hydrogen, oxidation of the melt and because elements characterized by low vapor pressure and high reactivity, upon to which mechanical properties directly or indirectly rely, may be lost from the melt. Turbulence or agitation of the melt and increased holding temperature significantly increase the rate of hydrogen solution, oxidation, and transient element loss. Furthermore, it is usually necessary to treat melts of aluminum and its alloys to remove suspended non-metallics using either solid or chemically active gaseous fluxes containing non-environmentally friendly substances such as chlorine, fluorine, chlorides, and/or fluorides. Pores and inclusions, whether in film or particle form, are namely damaging to the mechanical properties and the corrosion resistance of the final cast product. Precise control of casting parameters and conditions are therefore critical to achieve a cast product having the desired mechanical and corrosion properties.

Once a tap has been cast, holes for fluid channels have to be drilled in the cast tap, it has to be provided with any necessary thread and its outer surface has to be ground to get rid of any surface defects such as unevenness, cracks or ripples that may form as the cast tap solidifies and cools.

A problem may also be encountered when the finished aluminium tap is connected to a water pipe since water pipes are conventionally made of copper. When two or more different metals are placed in contact with each other in the presence of an electrolyte, a galvanic current is caused to flow through their point of contact at the expense of the metal with the higher electropotential which is gradually consumed in the ensuing electrochemical reaction until contact between the two metals is destroyed. Aluminium has an electropotential of +1.30 V whereas copper has an electropotential of −0.345 V. If an aluminium tap were connected to a copper pipe a high potential of 1.645 volts would be set up between these metals and, in the presence of water flowing through the water pipe and tap or remaining stagnant therein, the aluminum tap would be corroded away over a period of time, since, of the two metals, it possesses the higher electropotential. This problem does not occur when a brass tap is attached to a copper water pipe since brass typically contains 60-90% copper and so there is not such a large difference in electropotential between brass and copper.

### SUMMARY OF THE INVENTION

An object of the present invention is to provide an improved tap for connecting to a fluid outlet, such as a pipe.

This object is achieved by a tap comprising a part having a surface that is arranged to come into contact with a fluid, such as water, when the tap is in use, whereby at least said part is manufactured from extruded or forged aluminium or an extruded or forged aluminium alloy, i.e. either one or more of the internal or external parts of the tap are manufactured from extruded or forged aluminium or an extruded or forged aluminium alloy or substantially the entire tap is manufactured from extruded or forged aluminium or an extruded or forged aluminium alloy.

An extruded or forged aluminium tap is quicker, easier and cheaper to manufacture than a cast aluminium tap since complex internal and/or external structures can be produced quickly and inexpensively. Furthermore, the number of post-extruding/forging processes or steps such as drilling, turning, grinding or polishing of the extruded or forged product are either reduced (as compared with cast aluminium taps) or eliminated, while all of the benefits of using aluminium or an aluminium alloy are maintained.

Extrusion and forging avoid problems that are inherent to casting, which adversely affect the mechanical and/or corrosion properties of cast aluminium taps. Extrusion is a process in which a metal, often in the form of a billet, is pushed and/or drawn into a closed cavity through a die using either a mechanical or hydraulic press. Extrusion can produce a wide variety of cross-sections, including very thin sections, which are hard to produce cost-effectively using other methods, such as casting. Hollow sections may for example be extruded by placing pins or mandrels in the die, thus avoiding the need to drill holes in the extruded product. Hot extrusion is carried out at temperatures of approximately 50-75% of the melting point of the metal being extruded. In cold extrusion this process is carried out at room temperature or at slightly elevated temperatures. The advantages of cold extrusion are that no oxidation takes place, good mechanical properties are obtained if the temperature is kept below the re-crystallization temperature of the metal being extruded and a good surface finish can be obtained. In forging, a metal or alloy is shaped mechanically or hydraulically with or without heat.

According to an embodiment of the invention said at least one part of the tap is manufactured from an aluminium alloy from the 1000-7000 series of wrought aluminium alloys, preferably from the 6000-series, such as Aluminium Alloy EN-AW 6063 having the following composition (in weight-%):

### Silicon 0.20-0.60

### Iron up to 0.35

### Magnesium 0.45-0.90

### Manganese up to 0.10

### Copper up to 0.10

### Titanium up to 0.10

### Zinc up to 0.10

### Chromium up to 0.10

with the balance being Aluminium, other trace elements and inevitable impurities.

Alloys in the 6000-series utilize magnesium and silicon in various proportions to form magnesium silicide, which makes them heat treatable. The magnesium-silicon (or magnesium-silicide) alloys possess good formability and corrosion resistance with high strength.

According to another embodiment of the invention the tap comprises a coupling for connecting the tap to a fluid outlet, such as a copper pipe, having a substantially different electropotential than aluminium i.e. whereby the difference in electropotential is over one volt for example, whereby the coupling is manufactured from a non-metallic material, such as plastic or a composite material, or a metal or metal alloy, such as stainless steel, which has an electropotential that lies between that of aluminium and the fluid outlet material. The coupling isolates the tap from the fluid outlet and thus reduces galvanic currents flowing therebetween. It should be noted that the coupling may be a component that is mounted on a tap or a fluid outlet or a component that is integrally formed with the tap or the fluid outlet. Alternatively the coupling may be formed by soldering the contact surfaces of the tap and the fluid outlet together or by plating the contact surfaces with some rust-resisting metal whose electropotential lies between that of copper and aluminum, by hot tin dip plating for example.

According to an embodiment of the invention, the tap comprises a coupling for connecting said at least one part of the tap to a fluid outlet, whereby the coupling is manufactured from extruded or forged aluminium or an extruded or forged aluminium alloy and is formed integrally with the tap for applications in which the tap is connected to a non-metallic fluid outlet such as a plastic pipe.

According to a further embodiment of the invention the tap comprises means to maintain said at least one part of the tap at a higher voltage than the fluid outlet. If said at least one part of the tap is maintained at a higher voltage than the fluid inlet, electrons are prevented from being stripped from the metal with the higher electropotential constituting said at least one part of the tap, which consequently prevents it from corroding.

According to an embodiment of the invention said at least one part of the tap comprises a coating, for example on the surface that comes into contact with a fluid, such as water, when the tap is in use and/or on at least part of its inside and/or outside surface. The coating may for example be obtained by anodizing, chroming, plating or lacquering after said at least one part of the tap has been cleaned and primed.

According to another embodiment of the invention said at least one part of the tap comprises a sacrificial anode, i.e. a piece of metal that is more easily oxidized than aluminium. The readily corrodible metal is attached to said at least one part of the tap by either an electrically conductive solid or liquid so that it corrodes and dissolves completely before said at least one part of the tap will corrode.

According to a further embodiment of the invention said at least one part of the tap comprises fibres, whiskers or particulates to tailor the stiffness, strength, and thermal or aesthetic properties of the tap. The extrusion process can be used to orient fibres or whiskers, whereby said at least one part is, for example, stronger and stiffer in the direction of the fibres or whiskers than in a direction perpendicular to them, resulting in a tap or tap part with anisotropic properties. Since said at least one part of the tap can be made stiffer and/or stronger, thinner sections of material, and thereby less material, may be used to manufacture a tap, thus reducing its weight and transport costs.

The inventive tap is intended for use particularly, but not exclusively, to control the flow of drinking water.

### BRIEF DESCRIPTION OF THE DRAWINGS

The present invention will hereinafter be further explained by means of non-limiting examples with reference to the appended figures where;

FIG. 1 shows an extruded tap according to an embodiment of the invention,

FIG. 2 shows an extruded part of a tap according to an embodiment of the invention,

FIG. 3 shows an extruded tap comprising a coupling according to an embodiment of the invention, and

FIG. 4 shows an extruded tap according to another embodiment of the invention connected to a water pipe.

It should be noted that the drawings have not been drawn to scale and that the dimensions of certain features have been exaggerated for the sake of clarity.

### DETAILED DESCRIPTION OF EMBODIMENTS

FIG. 1 shows a tap 10 for a wash-basin, sink or bath, etc. The exemplified tap 10 has an extruded main body 10A comprising an inlet duct connected to the end of a water pipe 12 of a water network and an outlet duct that provides drinking water through a supply nozzle 10B of the tap 10, for example. The main body 10A contains a conventional valve assembly (not shown) that can be actuated by means of a single control lever 10C to selectively open and close fluid communication between the inlet duct and the outlet duct of the tap 10 and consequently to control the flow of water through the supply nozzle 10B.

In accordance with the present invention the entire main body 10A of the tap 10 or at least one internal part thereof having a surface that is arranged to come into contact with water when the tap 10 is in use is manufactured from extruded or forged aluminium or an extruded or forged aluminium alloy such as Aluminium Alloy 6063. The tap 10 is optionally anodized whereby an artificial oxide coating layer that provides increased corrosion protection and wear resistance is formed on the aluminum tap 10 or a part thereof.

The tap shown in FIG. 1 is for example manufactured by extruding the main body 10A including hollow cavities from an aluminium alloy, carrying out a reduced number of post-extrusion processes or steps (as compared with cast aluminium taps) such as providing the tap with thread, drilling holes in the tap, grinding, polishing and surface treating the tap, and mounting components such as the temperature and flow rate control means, control lever 10C and inlet pipes on/inside the extruded main body 10A.

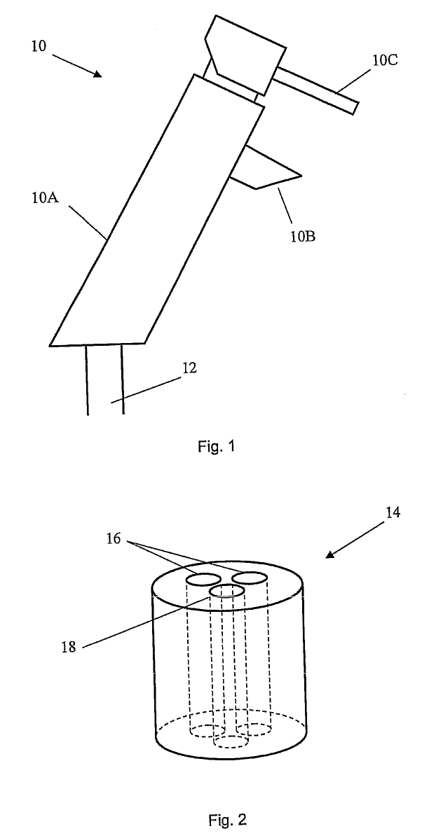

FIG. 2 schematically shows an extruded internal part 14 of a tap 10. Said part 14 comprises first and second channels 16 to transport hot and cold water from a respective water pipe 12 to the valve assembly inside the main body 10A of the tap 10 and a third channel 18 to transport water to a dishwasher, for example.

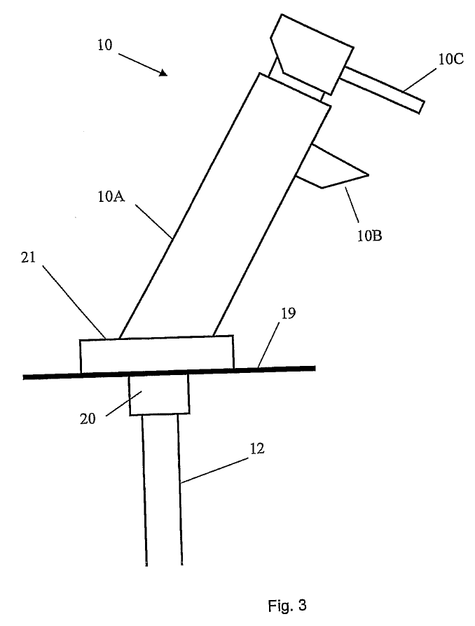

FIG. 3 shows an extruded or forged aluminium tap 10 according to an embodiment of the invention comprising a coupling 20 for connecting the tap 10 to a water pipe 12 manufactured from a material, such as copper, whose electropotential is significantly different to the electropotential of the tap material. The coupling 20 is manufactured from a non-metallic material, such as plastic or a composite material, or a metal or metal alloy, such as stainless steel. The coupling 20 isolates the tap 10 from the water pipe 12 to reduce galvanic currents therebetween. The tap may comprise further electrically isolating means, such as spacer 21, to electrically isolate the tap 10 from other metal fixtures, such as a kitchen sink 19.

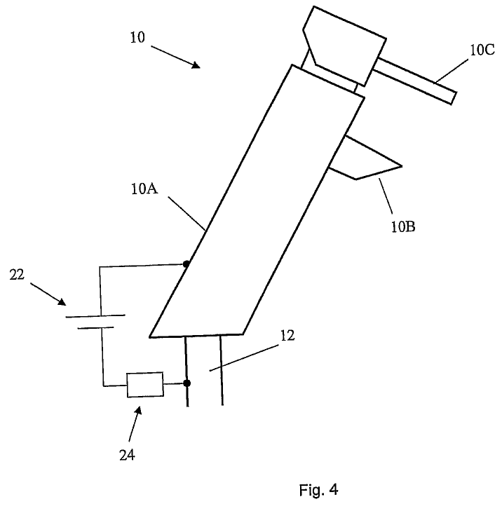

FIG. 4 shows an extruded or forged aluminium tap 10 according to an embodiment of the invention which is connected to a conventional copper water pipe 12 and comprises an electric circuit comprising an energy source, such as a battery 22 and optionally current limiting means, such as a resistor 24. The electric circuit maintains the tap 10 at a higher voltage than the water pipe 12 to hinder/prevent galvanic currents from corroding the tap 10. Alternatively or additionally the tap 10 may comprise a sacrificial anode (not shown). Such an electric circuit and/or a sacrificial anode may be used together with a coupling 20.

Further modifications of the invention within the scope of the claims would be apparent to a skilled person.

1. A tap ( ) for connecting to a water outlet, such as a pipe), whereby the tap ( ) comprises a part having a surface that is arranged to come into contact with water when the tap is in use, characterized in that at least said part (of the tap (is manufactured from extruded or forged aluminum or an extruded or forged aluminum alloy.

2. The tap ( ) according to claim 1, wherein said at least one part ( ) of the tap ( ) as manufactured from an aluminum alloy from the 1000-7000 series of wrought aluminum alloys, preferably from the 6000-series.

3. The tap ( ) according to claim 1, wherein said at least one part) of the tap) is manufactured from an aluminum alloy having the following composition (in weight-%):
Silicon 0.20-0.60
Iron up to 0.35
Magnesium 0.45-0.90
Manganese up to 0.10
Copper up to 0.10
Titanium up to 0.10
Zinc up to 0.10
Chromium up to 0.10
with the balance being Aluminum, other trace elements and inevitable impurities.

4. The tap ( ) according to claim 1, wherein it comprises a coupling ( ) for connecting the tap ( ) to a water outlet) having a substantially different electropotential than aluminum, whereby the coupling) is manufactured from a non-metallic material, such as plastic or a composite material, or a metal or metal alloy, such as stainless steel, which has an electropotential that lies between that of aluminum and the water outlet ( ) material.

5. The tap ( ) according to claim 1, wherein it comprises a coupling ( ) for connecting said at least one part ( ) of the tap ( ) to a water outlet, whereby the coupling ( ) is manufactured from extruded or forged aluminum or an extruded or forged aluminum alloy and is formed integrally with the tap).

6. The tap ( ) according to claim 1, wherein it comprises means) to maintain said at least one part ( ) of the tap ( ) at a higher voltage than the water outlet.

7. The tap ( ) according to claim 1, wherein said at least one part ( ) of the tap comprises a coating, such as one obtained by anodizing, chroming, plating or lacquering said at least one part (of the tap ( ).

8. The tap ( ) according to claim 1, wherein said at least one part ( ) of the tap ( ) comprises a sacrificial anode.

9. The tap ( ) according to claim 1, wherein said at least one part ( ) of the tap ( ) comprises fibres, whiskers or particulates.

10. A use of a tap) according to claim 1 to control the flow of drinking water.
